(19) United States
(12) Patent Application Publication
(10) Pub. No.: US 2026/0021739 A1
(43) Pub. Date: Jan. 22, 2026

(54) SYSTEM AND METHOD FOR PROVIDING CHARGING SERVICE FOR SEPARATE MOBILITY

(71) Applicants: Hyundai Motor Company, Seoul (KR); Kia Corporation, Seoul (KR)

(72) Inventors: Yuri Myoung, Hwaseong-si (KR); Jeong Chul Jung, Hwaseong-si (KR)

(21) Appl. No.: 18/971,713

(22) Filed: Dec. 6, 2024

(30) Foreign Application Priority Data
Jul. 18, 2024 (KR) 10-2024-0095269

(51) Int. Cl. B60L 53/66; B60L 53/68

(52) U.S. Cl. CPC B60L 53/665; B60L 53/68; B60L 2240/72

(57) ABSTRACT

A system for providing a charging service for a separate mobility can include a search processor searching for a near-distance charging station closest to a current location of a charging-required drive module or a near-distance residence module closest to the current location of the charging-required drive module, a charging cost calculation processor calculating a first charging cost expected to incur when using the near-distance charging station, and a second charging cost expected to incur when using the near-distance residence module, and a charging control processor determining whether the drive module is the charging-required drive module that is required to be charged based on a state of charge of the drive module, comparing the first charging cost with the second charging cost to select the near-distance charging station or the near-distance residence module as a charger, and controlling movement of the charging-required drive module to the charger.

### CROSS-REFERENCE TO RELATED APPLICATIONS

This application claims the priority and benefit of Korean Patent Application No. 10-2024-0095269, filed on July 18, 2024, which application is hereby incorporated herein by reference in its entirety.

### TECHNICAL FIELD

The present disclosure relates to system and method for providing a charging service for a separate mobility.

### BACKGROUND

Today, a vehicle used as a transportation system may include a drive part and a cabin part. The vehicle is unable to be used for a purpose other than the transportation system, and the vehicle not used as the transportation system may be maintained to be parked in a parking lot. That is, the vehicle not used as the transportation system may only occupy a parking space. In reality where an actual average operation time of the vehicle is only 5% of a life cycle of the vehicle, a large parking space and a high cost that a user is required to bear may be clear social losses. To solve this problem, designed is a separate mobility that includes a residence module that provides the user with a space the user needs and a drive module that is able to move the residence module.

In relation to the separate mobility, a businessperson who owns the plurality of drive modules may provide a mobility service that uses the drive module to move other person's residence module to his or her destination. The businessperson who provides the mobility service of the separate mobility may charge the drive module by moving or collecting/delivering the same to a charging station operated or designated by the businessperson when an amount of power of the drive module required for the business is insufficient. That is, the businessperson who provides the mobility service of the separate mobility is required to charge the drive module by moving or collecting/delivering the same to the charging station operated or designated by the business owner when the amount of power of the drive module is insufficient. Therefore, a work is required to move or collect/deliver the drive module to the charging station, which may cause a gap in business that is equivalent to a time required for this work.

### SUMMARY

An embodiment of the present disclosure can provide a service for providing a separate mobility, i.e., system and method for providing a charging service for a separate mobility, which may maximize energy efficiency by providing residual energy of a residence module to a drive module.

According to an embodiment of the present disclosure, provided is a system for providing a charging service for a separate mobility, and the system can include: a search processor searching for a near-distance charging station closest to a current location of a charging-required drive module or a near-distance residence module closest to the current location of the charging-required drive module; a charging cost calculation processor calculating a first charging cost expected to incur when the charging-required drive module uses the near-distance charging station by using the current location of the charging-required drive module, its required charging amount, and information on the near-distance charging station, and a second charging cost expected to incur when the charging-required drive module uses the near-distance residence module by using the current location of the charging-required drive module, its required charging amount, and information on the near-distance residence module; and a charging control processor determining whether the drive module is the charging-required drive module that is required to be charged based on a state of charge (SOC) of the drive module, comparing the first charging cost with the second charging cost to select one of the near-distance charging station and the near-distance residence module as a charger for the charging-required drive module, and controlling a movement of the charging-required drive module for the charging-required drive module to be charged using the selected charger.

The charging control processor may determine whether the drive module is required to be charged based on whether the SOC of a battery mounted on the drive module is a predetermined reference value or less.

The charging control processor may determine whether the charging-required drive module is providing a mobility service to a specific residence module.

The search processor may search for the near-distance charging station or the near-distance residence module based on an end point of the mobility service if it is determined that the charging-required drive module is providing the mobility service to the specific residence module.

The charging cost calculation processor may calculate the first charging cost by using a first moving time required for the charging-required drive module to move from its current location to the near-distance charging station, a first charging time expected to be required to fully charge the charging-required drive module at the near-distance charging station, the required charging amount, and a charging fee by charging amount at the near-distance charging station.

The charging cost calculation processor may calculate the second charging cost by using a second moving time required for the charging-required drive module to move from its current location to the near-distance residence module, a second charging time expected to be required to fully charge the charging-required drive module at the near-distance residence module, the required charging amount, and a charging fee by charging amount at the near-distance residence module.

The charging control processor may select the near-distance charging station as the charger for the charging-required drive module if the first charging cost is equal to or less than the second charging cost, and select the near-distance residence module as the charger for the charging-required drive module if the first charging cost is greater than the second charging cost.

The charging control processor may transmit, to the charging-required drive module, a signal instructing its movement to move to the near-distance charging station if the near-distance charging station is selected as the charger for the charging-required drive module.

The charging control processor may transmit a charging trade request signal to a terminal of an owner of the near-distance residence module if the near-distance residence module is selected as the charger for the charging-required drive module, transmit, to the charging-required drive module, a signal instructing its movement to the near-distance residence module when an acceptance signal is received from the terminal, and transmit the charging trade request signal to a terminal of an owner of a next-priority residence module or transmit, to the charging-required drive module, a signal instructing its movement to the near-distance charging station when a rejection signal is received from the terminal.

The charging control processor may determine that the charging trade request is rejected and perform the same operation as when the rejection signal is received from the terminal if there is no response to the charging trade request signal within a predetermined time.

The charging control processor may transmit a trade conclusion notification signal to a terminal of an owner of the near-distance residence module, and simultaneously transmits, to the charging-required drive module, a signal instructing its movement to the near-distance residence module when an automatic acceptance signal is received from the terminal.

The charging control processor may receive a charging trade offer signal from the residence module or a terminal to request a charge-providing residence module corresponding to the charging trade offer signal to transmit information on the charge-providing residence module, determine whether the charging trade offer signal includes an amount of power provided by the charge-providing residence module, transmit the information on the charge-providing residence module to the search processor if the charging trade offer signal includes the provided amount of power, and transmit the information on the charge-providing residence module to the charging cost calculation processor if the charging trade offer signal does not include the provided amount of power.

The search processor may search for a rechargeable drive module capable of being charged using the provided amount of power among the plurality of drive modules located within a designated radius based on a current location of the charge-providing residence module.

The search processor may search for the drive module among the plurality of drive modules, in which a difference between the battery maximum capacity and SOC of the drive module is greater than the provided amount of power, as the rechargeable drive module.

The search processor may search for the rechargeable drive module having a lowest SOC among the plurality of rechargeable drive modules as the rechargeable drive module having a highest priority when the plurality of rechargeable drive modules are searched for.

The charging cost calculation processor may calculate a difference between an available amount of power, which is stored in a battery mounted on the charge-providing residence module, and a reserve amount of power, which is expected to be required for the charge-providing residence module until a next charge of the charge-providing residence module, as the provided amount of power.

The charging cost calculation processor may calculate an expected amount of power for the movement by using the weight, aerodynamics, tire specification, motor output, reduction ratio, SOC, moving speed, or external temperature of the rechargeable drive module as a calculation factor.

The charging control processor may determine whether the rechargeable drive module is able to move to the charge-providing residence module by comparing the SOC received from the rechargeable drive module with the expected amount of power for the movement received from the charging cost calculation processor.

The charging control processor may transmit, to the rechargeable drive module, a signal instructing its movement to the charge-providing residence module if it is determined that the rechargeable drive module is able to move to the charge-providing residence module, and transmit, to the search processor, a signal for searching for another rechargeable drive module if it is determined that the rechargeable drive module is unable to move to the charge-providing residence module.

According to an embodiment, provided is a method for providing a charging service for a separate mobility, and the method can include: determining, by a charging control processor, whether a drive module is a charging-required drive module that is required to be charged based on a state of charge (SOC) of the drive module; searching for, by a search processor, a near-distance charging station closest to a current location of the charging-required drive module or a near-distance residence module closest to the current location of the charging-required drive module; calculating, by a charging cost calculation processor, a first charging cost expected to incur when the charging-required drive module uses the near-distance charging station by using the current location of the charging-required drive module, its required charging amount, and information on the near-distance charging station, and a second charging cost expected to incur when the charging-required drive module uses the near-distance residence module by using the current location of the charging-required drive module, its required charging amount, and information on the near-distance residence module; and comparing, by the charging control processor, the first charging cost with the second charging cost to select one of the near-distance charging station and the near-distance residence module as a charger for the charging-required drive module, and controlling a movement of the charging-required drive module for the charging-required drive module to be charged using the selected charger.

The determining whether the drive module is the charging-required drive module may include receiving the SOC of a battery mounted on the drive module from the drive module, and determining whether the drive module is required to be charged based on whether the SOC is a predetermined reference value or less.

The searching for the near-distance residence module may include determining, by the charging control processor, whether the charging-required drive module is providing a mobility service to a specific residence module, and searching for, by the search processor, the near-distance charging station or the near-distance residence module based on an end point of the mobility service if it is determined that the charging-required drive module is providing the mobility service to the specific residence module.

The calculating of the second charging cost may include calculating the first charging cost by using a first moving time required for the charging-required drive module to move from its current location to the near-distance charging station, a first charging time expected to be required to fully charge the charging-required drive module at the near-distance charging station, the required charging amount, and a charging fee by charging amount at the near-distance charging station, and calculating the second charging cost by using a second moving time required for the charging-required drive module to move from its current location to the near-distance residence module, a second charging time expected to be required to fully charge the charging-required drive module at the near-distance residence module, the required charging amount, and a charging fee by charging amount at the near-distance residence module.

The controlling of the movement of the charging-required drive module may include selecting the near-distance charging station as the charger for the charging-required drive module if the first charging cost is equal to or less than the second charging cost, selecting the near-distance residence module as the charger for the charging-required drive module if the first charging cost is greater than the second charging cost, and transmitting, to the charging-required drive module, a signal instructing its movement to the near-distance charging station if the near-distance charging station is selected as the charger for the charging-required drive module.

The controlling of the movement of the charging-required drive module may include transmitting a charging trade request signal to a terminal of an owner of the near-distance residence module if the near-distance residence module is selected as the charger for the charging-required drive module, determining whether an acceptance signal is received from the terminal, transmitting, to the charging-required drive module, a signal instructing its movement to the near-distance residence module when the acceptance signal is received from the terminal, and transmitting the charging trade request signal to a terminal of an owner of a next-priority residence module or transmitting, to the charging-required drive module, a signal instructing its movement to the near-distance charging station when a rejection signal is received from the terminal.

The controlling of the movement of the charging-required drive module may include determining, by the charging control processor, that the charging trade request is rejected and performing the same operation as when the rejection signal is received from the terminal if there is no response to the charging trade request signal within a predetermined time.

The controlling of the movement of the charging-required drive module may include transmitting, by the charging control processor, a trade conclusion notification signal to a terminal of an owner of the near-distance residence module, and simultaneously transmitting, to the charging-required drive module, a signal instructing its movement to the near-distance residence module when an automatic acceptance signal is received from the terminal.

According to an embodiment, provided is a method for providing a charging service for a separate mobility, and the method can include: receiving, by a charging control processor, a charging trade offer signal from a residence module or a terminal to request a charge-providing residence module corresponding to the charging trade offer signal to transmit information on the charge-providing residence module; determining, by the charging control processor, whether the charging trade offer signal includes an amount of power provided by the charge-providing residence module; searching for, by a search processor, a rechargeable drive module capable of being charged using the provided amount of power among the plurality of drive modules located within a designated radius based on a current location of the charge-providing residence module if the charging trade offer signal includes the amount of power provided by the charge-providing residence module; receiving, by a charging cost calculation processor, information on the rechargeable drive module from the search processor, and calculating an expected amount of power for a movement of the rechargeable drive module by using the information on the rechargeable drive module; determining, by the charging control processor, whether the rechargeable drive module is able to move by comparing a state of charge (SOC) received from the rechargeable drive module with the expected amount of power for the movement received from the charging cost calculation processor, and controlling the movement of the rechargeable drive module for the rechargeable drive module to be charged using the charge-providing residence module if it is determined that the rechargeable drive module is able to move.

The determining whether the charging trade offer signal includes the provided amount of power may include transmitting, by the charging control processor, the information on the charge-providing residence module to the search processor if the charging trade offer signal includes the provided amount of power, transmitting, by the charging control processor, the information on the charge-providing residence module to the charging cost calculation processor, and calculating a difference between an available amount of power, which is stored in a battery mounted on the charge-providing residence module, and a reserve amount of power, which is expected to be required for the charge-providing residence module until a next charge of the charge-providing residence module, as the provided amount of power if the charging trade offer signal does not include the provided amount of power.

The searching for the rechargeable drive module may include searching for, by the search processor, the drive module among the plurality of drive modules, in which a difference between the battery maximum capacity and SOC of the drive module is greater than the provided amount of power, as the rechargeable drive module.

The searching for the rechargeable drive module may include searching for, by the search processor, the rechargeable drive module having a lowest SOC among the plurality of rechargeable drive modules as the rechargeable drive module having a highest priority when the plurality of rechargeable drive modules are searched for.

In the calculating of the expected amount of power for the movement, the expected amount of power for the movement may be calculated by the charging cost calculation processor by using the weight, aerodynamics, tire specification, motor output, reduction ratio, SOC, moving speed, or external temperature of the rechargeable drive module as a calculation factor.

The controlling of the movement of the rechargeable drive module may include determining whether the rechargeable drive module is able to move by comparing the SOC of the rechargeable drive module with the expected amount of power for the movement, transmitting, to the rechargeable drive module, a signal instructing its movement to the charge-providing residence module if it is determined that the rechargeable drive module is able to move to the charge-providing residence module, and transmitting, to the search processor, a signal for searching for another rechargeable drive module if it is determined that the rechargeable drive module is unable to move to the charge-providing residence module.

According to an embodiment of the present disclosure, the smooth power trade may be achieved between the owner of the residence module and an owner of the drive module.

According to an embodiment of the present disclosure, the residual energy of the residence module may be provided to the drive module, and the energy consumed in moving the residence module to the charging station for its charging may be reduced, thereby improving the energy efficiency in the service for providing the separate mobility.

Advantages that may be acquired from use of an embodiment of the present disclosure are not necessarily limited to those mentioned above, and other advantages that are not mentioned here can be understood by those skilled in the art to which the present disclosure pertains from the following description.

### BRIEF DESCRIPTION OF THE DRAWINGS

FIG. 1 is a diagram for explaining a process where a system for providing a charging service for a separate mobility according to an embodiment of the present disclosure communicates with a terminal, a residence module, and a drive module.

FIG. 2 is a block diagram of the system for providing a charging service for a separate mobility according to an embodiment of the present disclosure.

FIG. 3 is a flowchart of a method for providing a charging service for a separate mobility according to a first example embodiment of the present disclosure.

FIG. 4 is a flowchart of a method for providing a charging service for a separate mobility according to a second example embodiment of the present disclosure.

### DETAILED DESCRIPTION OF ILLUSTRATIVE EMBODIMENTS

In describing example embodiments of the present disclosure, omitted can be a detailed description of a case where it is decided that a detailed description for the known art related to the present disclosure may obscure the gist of the embodiment of the present disclosure. It can be understood that the accompanying drawings are provided to allow the example embodiments of the present disclosure to be easily understood, and the spirit of the present disclosure is not necessarily limited to the accompanying drawings and includes all modifications, equivalents, and substitutions included in the spirit and scopes of the present disclosure.

Terms including ordinal numbers such as "first", "second" and the like, may be used to describe various components. However, these components are not necessarily limited to these terms. These terms can be used merely to distinguish one component and another component from each other.

It can be understood that if one component is referred to as being "connected to" or "coupled to" another component, one component may be directly connected to or directly coupled to another component, or may be connected to or coupled to another component while having a third component interposed therebetween. On the other hand, it can be understood that if one component is referred to as being "directly connected to" or "directly coupled to" another component, one component may be connected or coupled to another component without a third component interposed therebetween.

It can be further understood that the terms such as "comprise", "include" and the like, used in the specification specify the presence of features, numerals, steps, operations, components, parts, or combinations thereof, mentioned in the specification, and do not preclude the presence or addition of one or more other features, numerals, steps, operations, components, parts, or combinations thereof.

Hereinafter, example embodiments of the present disclosure are described in detail with reference to the accompanying drawings.

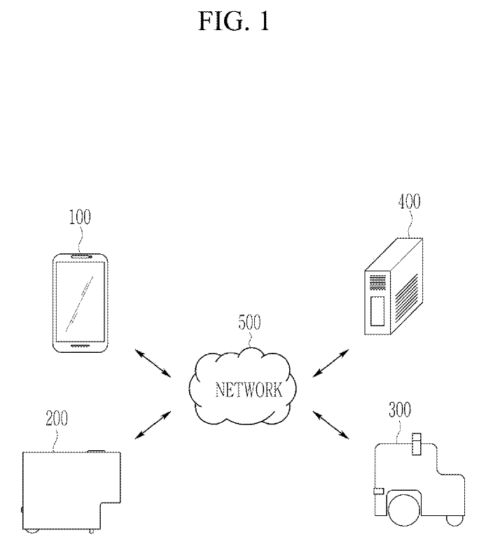

FIG. 1 is a diagram for explaining a process where a system 400 for providing a charging service for a separate mobility according to an embodiment of the present disclosure communicates with a terminal 100, a residence module 200, and a drive module 300.

Referring to FIG. 1, the system 400 for providing a charging service for a separate mobility according to an embodiment of the present disclosure may communicate with the terminal 100, the residence module 200 and the drive module 300 through a network 500.

The terminal 100 may be a communication device that provides a user with information related to the charging service for a separate mobility and may receive, from the user, information for providing the charging service for a separate mobility. For example, the terminal 100 may be a computer, a tablet PC, a wireless phone, a mobile phone, a smartphone, a smart watch, a smart glass, a portable game console, or the like that may perform communication.

The terminal 100 may receive a charging trade request signal from the system 400 for providing a charging service for a separate mobility. The terminal 100 may receive an acceptance or rejection signal in response to the charging trade request signal from the user and transmit the same to the system 400 for providing a charging service for a separate mobility. A charging trade can indicate that an owner of the residence module 200 provides power of the residence module 200 for charging the drive module 300, and an owner of the drive module 300 can pay a certain fee to the owner of the residence module 200 in return for received power. The terminal 100 may receive a charging trade offer signal from the user and transmit the same to the system 400 for providing a charging service for a separate mobility.

The residence module 200 may provide the user with a space that may be used for a specific purpose. The residence module 200 may be moved while coupled with the drive module 300, and moved by directly/indirectly receiving power generated by the drive module 300. Accordingly, the user may use a desired space at any location through the residence module 200. For example, the user may use the residence module 200 as a living space or storage, and if its movement is necessary, the user may call the drive module 300 to couple the drive module 300 to the residence module 200, and then move the residence module 200 to a desired location. According to an embodiment, the residence module 200 may have various forms based on the user's purpose of use. For example, electrical equipment, home appliances, and furniture may be installed in the residence module 200 used as the living space.

The residence module 200 may include a battery storing energy used by the residence module 200 or the drive module 300. A capacity of the battery included in the residence module 200 may be set in various ways based on the size, weight, and the like of the residence module 200. The residence module 200 may calculate its current location by using a global positioning system (GPS), or the like, and transmit the calculated current location to the terminal 100 or the system 400 for providing a charging service for a separate mobility.

The drive module 300 may be used as the transportation system to provide a mobility service of moving the residence module 200 to a specific location (hereinafter, ‘destination’) by receiving a call instruction from the terminal 100. The call instruction indicates an instruction to call the drive module 300 to the current location (hereinafter, "call location") of the residence module 200, and includes information such as the schedule, usage time, call location, and destination that the user wants to move the residence module 200 by using the drive module 300. That is, the drive module 300 is a device that may generate power and move on its own, and may be coupled with the residence module 200 to move the residence module 200 to the destination.

The drive module 300 may be the transportation system that may perform autonomous driving. The drive module 300 may be an economical, standard, or high-performance type. The drive module 300 may include a battery storing energy for moving the drive module 300 and the residence module 200. A capacity of the battery included in the drive module 300 may be set in various ways based on the type, size, weight, and the like of the drive module 300. For example, the economical drive module 300 may be a module mounted with a low output motor and a high capacity battery, the standard drive module 300 may be a module mounted with a medium output motor and a medium capacity battery, and the high-performance drive module may be a module mounted with a high output motor and a low capacity battery.

The drive module 300 may measure a current battery capacity (state of charge, SOC) of the battery mounted on the drive module 300, and transmit the measured SOC to the system 400 for providing a charging service for a separate mobility.

The network 500 can indicate a connection structure that enables information exchange between each node, such as the terminal 100, the residence module 200, the drive module 300, or the system 400 for providing a charging service for a separate mobility. For example, the network 500 may include a local area network (LAN), a wide area network (WAN), the Internet (World Wide Web, WWW), a wired or wireless data communication network, a telephone network, a wired or wireless television network, or the like. A wireless data communication network may include 3rd generation (3G), 4th generation (4G), 5th generation (5G), 3 rd Generation Partnership Project (3GPP), long term evolution (LTE), world interoperability for microwave access (WIMAX), wireless fidelity (Wi-Fi), Bluetooth communication, infrared communication, ultrasonic communication, visible light communication (VLC), light fidelity (LiFi), or the like, and is not necessarily limited thereto.

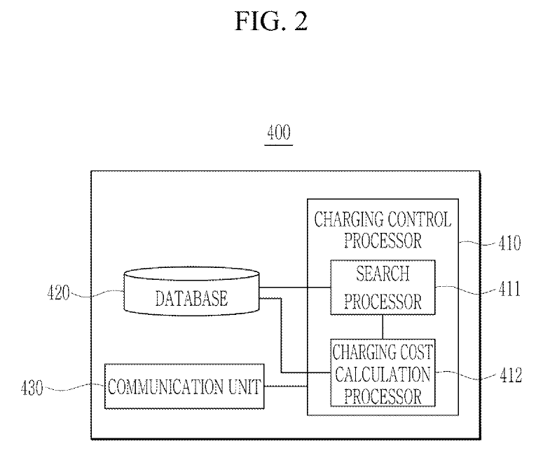

Hereinafter, the description describes the system 400 for providing a charging service for a separate mobility according to an embodiment of the present disclosure in detail with reference to FIG. 2.

FIG. 2 is a block diagram of the system 400 for providing a charging service for a separate mobility according to an embodiment of the present disclosure.

Referring to FIG. 2, the system 400 for providing a charging service for a separate mobility according to an embodiment of the present disclosure may include a charging control processor 410, a database 420, and a communication unit 430. According to an embodiment, the charging control processor 410 may include a search processor 411 and a charging cost calculation processor 412.

The charging control processor 410 may receive the SOC of the battery mounted on the drive module 300 from the drive module 300. The charging control processor 410 may determine whether the drive module 300 is required to be charged based on whether the SOC is a predetermined reference value or less. For example, if the SOC received from the drive module 300 is 20% or less, the charging control processor 410 may determine that the drive module 300 is required to be charged. The charging control processor 410 may request the drive module 300 (hereinafter, the "the charging-required drive module") that is determined to be required to be charged to transmit information on the charging-required drive module. The charging control processor 410 may transmit the information on the charging-required drive module to the search processor 411 and the charging cost calculation processor 412. The information on the charging-required drive module may include the current location, size, weight, output, SOC, or the like of the charging-required drive module.

The charging control processor 410 may receive a first charging cost and a second charging cost from the charging cost calculation processor 412. The first charging cost can indicate a cost expected to incur when the charging-required drive module uses a charging station (hereinafter, "near-distance charging station") closest to its current location, and the second charging cost can indicate a cost expected to incur when the charging-required drive module uses the residence module 200 (hereinafter, "near-distance residence module") closest to its current location.

The near-distance residence module can be the residence module 200 that is previously subscribed to the charging service for a separate mobility, and can indicate the residence module 200 that may supply power to the charging-required drive module based on the request of the drive module 300 or the system 400 for providing a charging service for a separate mobility.

The charging control processor 410 may compare the first charging cost with the second charging cost to select one of the near-distance charging station or the near-distance residence module as a charger for the charging-required drive module. For example, the charging control processor 410 may select the near-distance charging station as the charger for the charging-required drive module if the first charging cost is equal to or less than the second charging cost. Alternatively, the charging control processor 410 may select the near-distance residence module as the charger for the charging-required drive module if the first charging cost is greater than the second charging cost.

The charging control processor 410 may control the charging-required drive module to be charged using the selected charger. The charging control processor 410 may transmit, to the charging-required drive module, a signal instructing its movement to the near-distance charging station if the near-distance charging station is selected as the charger for the charging-required drive module. The charging control processor 410 may transmit the charging trade request signal to the terminal 100 of an owner of the near-distance residence module if the near-distance residence module is selected as the charger for the charging-required drive module. The charging control processor 410 may receive the acceptance or rejection signal for the charging trade request from the terminal 100 of the owner of the near-distance residence module.

The charging control processor 410 may transmit, to the charging-required drive module, a signal instructing its movement to the near-distance residence module when the acceptance signal (that is, when the charging trade is concluded) is received. According to an embodiment, the charging control processor 410 may receive an automatic acceptance signal from the terminal 100 of the owner of the near-distance residence module. The automatic acceptance signal indicates a signal generated by the terminal 100 when the terminal 100 of the owner of the near-distance residence module is set to automatically accept the charging trade in a case of receiving the charging trade request from the charging control processor 410. The charging control processor 410 may transmit a trade conclusion notification signal to the terminal 100, and simultaneously transmit, to the charging-required drive module, a signal instructing its movement to the near-distance residence module when the automatic acceptance signal is received.

The charging control processor 410 may transmit the charging trade request to the terminal 100 of an owner of the next-priority residence module 200 when the rejection signal is received. The next-priority residence module 200 may indicate the residence module 200 that is closest to the current location of the charging-required drive module after the near-distance residence module. Alternatively, the charging control processor 410 may transmit, to the charging-required drive module, a signal instructing its movement to the near-distance charging station. According to an embodiment, the charging control processor 410 may determine that the charging trade request is rejected and perform the same operation as when the rejection signal is received from the terminal 100 if there is no response to the charging trade request signal within a predetermined time.

The charging control processor 410 may receive the charging trade offer signal from the residence module 200 or the terminal 100. When the charging trade offer signal is received, the charging control processor 410 may request the residence module 200 (hereinafter, "charge-providing residence module") corresponding to the charging trade offer signal to transmit information on the charging-providing residence module. The information on the charge-providing residence module may include a current location of the charge-providing residence module, an amount of power available in the charge-providing residence module, a daily average power usage of the charge-providing residence module, a charging pattern of the charge-providing residence module by day and time of the week.

The charging control processor 410 may determine whether the received charging trade offer signal includes an amount of power (hereinafter, "provided amount of power") that may be provided by the charge-providing residence module. The charging control processor 410 may transmit the information on the charge-providing residence module to the search processor 411 if the charging trade offer signal includes the provided amount of power, and transmit the information on the charge-providing residence module to the charging cost calculation processor 412 if the charging trade offer signal does not include the provided amount of power.

The charging control processor 410 may receive, from the search processor 411, information on the drive module 300 (hereinafter, "drive module capable of being charged") that may be charged using the provided amount of power. The charging control processor 410 may receive, from the charging cost calculation processor 412, an amount of power expected to be required to move the rechargeable drive module to the charge-providing residence module (hereinafter, "expected amount of power for the movement"). The information on the rechargeable drive module may include the current location, average moving speed, weight, size, tire specification, motor output, reduction ratio, external temperature, SOC, or the like of the rechargeable drive module.

The charging control processor 410 may determine whether the rechargeable drive module is able to move to the charge-providing residence module by comparing the SOC of the rechargeable drive module with the expected amount of power for the movement. For example, the charging control processor 410 may determine that the rechargeable drive module is able to move to the charge-providing residence module if the SOC of the rechargeable drive module is equal to or greater than the expected amount of power for the movement. Alternatively, the charging control processor 410 may determine that the rechargeable drive module is unable to move to the charge-providing residence module if the SOC of the rechargeable drive module is less than the expected amount of power for the movement.

The charging control processor 410 may transmit, to the rechargeable drive module, a signal instructing its movement to the charge-providing residence module if it is determined that the rechargeable drive module is able to move to the charge-providing residence module. The charging control processor 410 may transmit, to the search processor 411, a signal for searching for another rechargeable drive module if it is determined that the rechargeable drive module is unable to move to the charge-providing residence module.

The search processor 411 may search for the nearest charging station, that is, the near-distance charging station based on the current location of the charging-required drive module. The search processor 411 may search the database 420 for information on the corresponding near-distance charging station and transmit the same to the charging cost calculation processor 412. The information on the near-distance charging station may include a location of the near-distance charging station, a weight value of an area where the near-distance charging station is located, a charging fee by charging amount, or the like. The weight value is a variable for converting time into cost, and may be set differently based on a demand for the charging service for a separate mobility in each area. That is, the weight value may be increased if there is a high demand for the charging service in a specific area, and the weight value may be decreased if there is a low demand for the charging service.

The search processor 411 may search for the nearest residence module 200 based on the current location of the charging-required drive module, that is, the near-distance residence module. The search processor 411 may search the database 420 for information on the near-distance residence module and transmit the same to the charging cost calculation processor 412. The information on the near-distance residence module may include a location of the near-distance residence module, a weight value of an area where the near-distance residence module is located, a charging fee by charging amount, or the like.

According to an embodiment, the search processor 411 may search for the near-distance charging station or the near-distance residence module based on an end point of the mobility service being provided if the charging-required drive module is providing the mobility service to a specific residence module 200. The end point of the mobility service may be information received from the charging-required drive module.

The search processor 411 may search for the rechargeable drive module capable of being charged using the provided amount of power of the charge-providing residence module among the plurality of drive modules 300 located within a designated radius based on the current location of the charge-providing residence module. The search processor 411 may receive the searched information on the rechargeable drive module from the rechargeable drive module or the database 420, and transmit the same to the charging control processor 410 or the charging cost calculation processor 412. The information on the rechargeable drive module may include the current location, average moving speed, weight, size, SOC, or the like of the rechargeable drive module.

According to an embodiment, the search processor 411 may search for the drive module 300 among the plurality of drive modules 300, in which a difference between its battery maximum capacity and SOC is greater than the provided amount of power of the charge-providing residence module, as the rechargeable drive module.

According to an embodiment, the search processor 411 may search for the rechargeable drive module having the lowest SOC among the plurality of rechargeable drive modules or the rechargeable drive module that is closest to the charge-providing residence module as the rechargeable drive module having the highest priority when searching the plurality of rechargeable drive modules.

The charging cost calculation processor 412 may receive the current location, SOC, or the like of the charging-required drive module from the charging control processor 410, and receive the information on the near-distance charging station and the near-distance residence module from the search processor 411.

The charging cost calculation processor 412 may calculate the charging amount (hereinafter, "required charging amount") required to fully charge the charging-required drive module based on the SOC of the charging-required drive module. The required charging amount can indicate power expected to be required to fully charge the charging-required drive module, and the required charging amount may be calculated using various methods known in advance.

The charging cost calculation processor 412 may calculate the first charging cost expected to incur when fully charging the charging-required drive module at the near-distance charging station by using the current location of the charging-required drive module, the required charging amount, and the information on the near-distance charging station. According to an embodiment, the charging cost calculation processor 412 may calculate the first charging cost by using a first moving time of the charging-required drive module, a first charging time, the required charging amount, and the charging fee by charging amount at the corresponding near-distance charging station. The first moving time can indicate a time required for the charging-required drive module to move from its current location to the near-distance charging station, and may be calculated by dividing a distance from the current location of the charging-required drive module to the near-distance charging station by the average speed of the charging-required drive module. The first charging time can indicate a time expected to fully charge the charging-required drive module, and may be calculated by dividing the required charging amount by the average charging rate of the near-distance charging station. For example, the charging cost calculation processor 412 may calculate the first charging cost by using [Equation 1] below.

[Equation 1] First charging cost = ((first moving time + first charging time) x weight value) + (charging fee at near-distance charging station x required charging amount)

The charging cost calculation processor 412 may calculate the second charging cost expected to be required to fully charge the charging-required drive module at the near-distance residence module by using the information on the current location of the charging-required drive module, the required charging amount, and the near-distance residence module. According to an embodiment, the charging cost calculation processor 412 may calculate the second charging cost by using a second moving time of the charging-required drive module, a second charging time, the required charging amount, and the charging fee by charging amount at the corresponding near-distance residence module. The second moving time can indicate a time required for the charging-required drive module to move from its current location to the near-distance residence module, and may be calculated by dividing a distance from the current location of the charging-required drive module to the near-distance residence module by the average speed of the charging-required drive module. The second charging time can indicate an expected time to fully charge the charging-required drive module, and may be calculated by dividing the required charging amount by the average charging rate at the near-distance residence module. For example, the charging cost calculation processor 412 may calculate the second charging cost by using [Equation 2] below.

[Equation 2] Second charging cost = ((second moving time + second charging time) x weight value) + (charging fee at near-distance residence module x required charging amount)

The charging cost calculation processor 412 may calculate the provided amount of power by using an algorithm for calculating the provided amount of power. The algorithm for calculating the provided amount of power may be an algorithm for calculating a difference between the available amount of power and reserve amount of power of the charge-providing residence module as the provided amount of power. The available amount of power can indicate an amount of power currently stored in the battery mounted on the charge-providing residence module, and the reserve amount of power can indicate an amount of power expected to be required for the charge-providing residence module until the next charge.

The charging cost calculation processor 412 may receive the information on the charge-providing residence module from the charging control processor 410. The information on the charge-providing residence module may include the current location of the charge-providing residence module, the available amount of power of the charge-providing residence module, the daily average power usage of the charge-providing residence module, and the charging pattern of the charge-providing residence module by day and time of the week, or the like.

According to an embodiment, the charging cost calculation processor 412 may calculate the reserve amount of power based on the daily average power usage of the charge-providing residence module and its charging pattern by day and time of the week. For example, assuming that the daily average power usage is 3 kWh and that there is the charge-providing residence module having the charging pattern where the charging starts at 1 pm every Monday, the reserve amount of power of a specific charge-providing residence module that is calculated at 1 pm on Wednesday may be calculated (12 kWh) by multiplying the daily average power usage (3 kWh) by a time remaining until the next charge (4 days).

According to an embodiment, the charging cost calculation processor 412 may calculate the reserve amount of power based on a usage mode of the charge-providing residence module. For example, when the charge-providing residence module is in a relaxation mode, its power consumption may be minimized by operating the minimum lighting, sound, and air conditioning system, and the daily average power usage may thus be assumed to be 1 kW; when the charge-providing residence module is in a work mode, its power consumption may be increased compared to the relax mode by operating the partial lighting, air conditioning, and the function of the network 500, and the daily average power usage may be assumed to be 2 kW; and when the charge-providing residence module in an entertainment mode, its power consumption may reach the maximum by using the large screen, large sound, and increased use of the network 500, and the daily average power usage may be assumed to be 3 kW. The charging cost calculation processor 412 may calculate the reserve amount of power by multiplying the daily average power usage assumed for each mode by the time remaining until the next charge.

The charging cost calculation processor 412 may receive the information on the rechargeable drive module from the search processor 411. The charging cost calculation processor 412 may calculate the expected amount of power for the movement by using the weight, aerodynamics, tire specification, motor output, reduction ratio, SOC, moving speed, external temperature, or the like of the rechargeable drive module as a calculation factor, and transmit the calculated expected amount of power for the movement to the charging control processor 410. For example, the charging cost calculation processor 412 may calculate a moving time required for the rechargeable drive module to move from its current location to the charge-providing residence module based on the current location of the rechargeable drive module, the current location of the charge-providing residence module, the average moving speed of the rechargeable drive module, or the like. The charging cost calculation processor 412 may calculate the expected amount of power for the movement by multiplying the moving time by an hourly average amount of power used by the rechargeable drive module.

The database 420 may store the information on the charging-required drive module, the information on the charge-providing residence module, the information on the rechargeable drive module, the information on the near-distance charging station, the information on the near-distance residence module, or the like.

The communication unit 430 may communicate with the terminal 100, the residence module 200, the drive module 300 through the network 500.

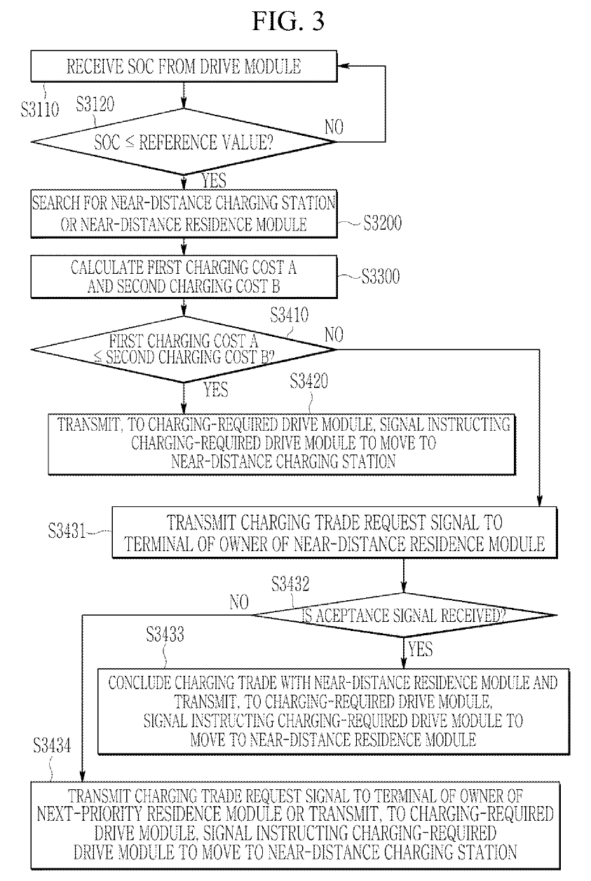

FIG. 3 is a flowchart of a method for providing a charging service for a separate mobility according to a first embodiment of the present disclosure. Referring to FIG. 3, the method for providing a charging service for a separate mobility according to the first embodiment of the present disclosure may determine whether the drive module 300 is required to be charged by using the SOC received from the drive module 300, and search for the near-distance charging station or the near-distance residence module, which may charge the charging-required drive module.

Referring to FIG. 3, the method for providing a charging service for a separate mobility according to the first embodiment of the present disclosure may include: determining whether the drive module 300 is required to be charged (operations S3110-S3120, collectively referred to as S3100); searching for the near-distance charging station or the near-distance residence module (operation S3200); calculating the first charging cost and the second charging cost (operation S3300); and selecting the charger, and controlling charging of the charging-required drive module (operations 3410-3434, collectively referred to as S3400).

In the determining whether the drive module 300 is required to be charged, the charging control processor 410 may determine whether the corresponding drive module 300 is the charging-required drive module based on the SOC of the drive module 300. If it is determined that the drive module 300 is the charging-required drive module, the charging control processor 410 may transmit the information on the charging-required drive module to the search processor 411 or the charging cost calculation processor 412. If it is determined that the drive module 300 is not the charging-required drive module, the charging control processor 410 may determine whether another drive module 300 is the charging-required drive module.

According to this embodiment, the determining whether the drive module 300 is required to be charged (S3100) may include receiving the SOC of the battery mounted on the drive module 300 from the drive module 300 (operation S3110) and determining whether the drive module 300 is required to be charged based on whether the received SOC is the predetermined reference value or less (operation S3120).

In the searching for the near-distance charging station or the near-distance residence module (operation S3200), the search processor 411 may search for the near-distance charging station or the near-distance residence module based on the current location of the charging-required drive module. The search processor 411 may search the database 420 for the information on the near-distance charging station or the near-distance residence module and transmit the same to the charging cost calculation processor 412. The near-distance charging station indicates the nearest charging station based on the current location of the charging-required drive module, and the near-distance residence module indicates the residence module 200 that is closest based on the current location of the charging-required drive module.

According to this embodiment, the searching for the near-distance charging station or the near-distance residence module (operation S3200) may include determining whether the charging-required drive module is providing the mobility service for the specific residence module 200, and searching for the near-distance charging station or the near-distance residence module based on the end point of the mobility service being provided if the charging-required drive module is providing the mobility service.

In the calculating of the first charging cost and the second charging cost (operation S3300), the charging cost calculation processor 412 may calculate the first charging cost and the second charging cost by using the current location of the charging-required drive module, the required charging amount, the information on the near-distance charging station, and the information on the near-distance residence module. The first charging cost indicates the cost expected to incur when the charging-required drive module uses the near-distance charging station, and the second charging cost indicates the cost expected to incur when the charging-required drive module uses the near-distance residence module.

According to this embodiment, the calculating of the first charging cost and the second charging cost (operation S3300) may include calculating, by the charging cost calculation processor 412, the first charging cost by using the first moving time required for the charging-required drive module to move from its current location to the near-distance charging station, the first charging time expected to be required to fully charge the charging-required drive module at the near-distance charging station, the required charging amount, and the charging fee by charging amount at the near-distance charging station, and calculating, by the charging cost calculation processor 412, the second charging cost by using the second moving time required for the charging-required drive module to move from its current location to the near-distance residence module, the second charging time expected to be required to fully charge the charging-required drive module at the near-distance residence module, the required charging amount, and the charging fee by charging amount at the near-distance residence module.

In the selecting of the charger, and the controlling of charging of the charging-required drive module (operations S3400), the charging control processor 410 may compare the first charging cost with the second charging cost to select one of the near-distance charging station and the near-distance residence module as the charger for the charging-required drive module, and control the charging-required drive module to be charged using the selected charger.

According to this embodiment, the selecting of the charger, and the controlling of charging of the charging-required drive module (operations S3400) may include selecting, by the charging control processor 410, the near-distance charging station as the charger for the charging-required drive module when the first charging cost is equal to or less than the second charging cost, and selecting, by the charging control processor 410, the near-distance residence module as the charger for the charging-required drive module when the first charging cost is greater than the second charging cost (operation S3410), and transmitting, to the charging-required drive module, the signal instructing its movement to the near-distance charging station when the near-distance charging station is selected as the charger for the charging-required drive module (operation S3420).

According to this embodiment, the selecting of the charger, and the controlling of charging of the charging-required drive module (operations S3400) may include transmitting the charging trade request signal to the terminal 100 of the owner of the near-distance residence module if the near-distance residence module is selected as the charger for the charging-required drive module (operation S3431), determining whether the acceptance signal is received from the terminal 100 (operation S3432), transmitting, to the charging-required drive module, the signal instructing its movement to the near-distance residence module if the acceptance signal is received from the terminal 100 (operation S3433), and transmitting the charging trade request signal to the terminal 100 of the owner of the next-priority residence module 200 or transmitting, to the charging-required drive module, the signal instructing its movement to the near-distance charging station if the rejection signal is received from the terminal 100 (operation S3434).

According to this embodiment, in the selecting of the charger, and the controlling of charging of the charging-required drive module (operations S3400), the charging control processor 410 may transmit the trade conclusion notification signal to the terminal 100, and simultaneously transmit, to the charging-required drive module, the signal instructing its movement to the near-distance residence module when the automatic acceptance signal is received.

According to this embodiment, in the selecting of the charger, and the controlling of charging of the charging-required drive module (operations S3400), the charging control processor 410 may determine that the charging trade request is rejected and perform the same operation as when the rejection signal is received from the terminal 100 if there is no response to the charging trade request signal within the predetermined time.

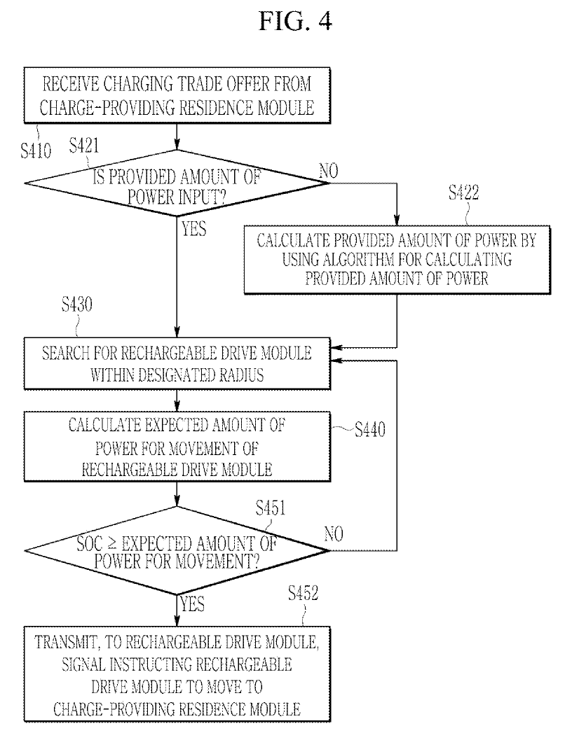

FIG. 4 is a flowchart of a method for providing a charging service for a separate mobility according to a second embodiment of the present disclosure. Referring to FIG. 4, in the method for providing a charging service for a separate mobility according to the second embodiment of the present disclosure, the charging trade offer signal of the user may be received from the terminal 100, and the charging-required drive module capable of receiving power from the residence module 200 corresponding to the received charging trade offer signal may be searched for.

Referring to FIG. 4, the method for providing a charging service for a separate mobility according to the second embodiment of the present disclosure may include: receiving the charging trade offer (operation S410); determining whether the provided amount of power is input; searching for the rechargeable drive module (operation S430); calculating the expected amount of power for the movement (operation S440); and determining whether the rechargeable drive module is able to move.

In the receiving of the charging trade offer (operation S410), the charging control processor 410 may receive the charging trade offer signal from the residence module 200 or the terminal 100. When the charging trade offer signal is received, the charging control processor 410 may request the charge-providing residence module corresponding to the charging trade offer signal to transmit the information on the charge-providing residence module.

In the determining whether the provided amount of power is input, the charging control processor 410 may determine whether the provided amount of power of the charge-providing residence module is included in the received charging trade offer signal, transmit the information on the charge-providing residence module to the search processor 411 if the charging trade offer signal includes the provided amount of power, and transmit the information on the charge-providing residence module to the charging cost calculation processor 412 if the charging trade offer signal does not include the provided amount of power.

According to this embodiment, the determining whether the provided amount of power is input may include transmitting the information on the charge-providing residence module to the search processor 411 if the charging trade offer signal includes the provided amount of power (operation S421), and calculating, by the charging cost calculation processor 412, the provided amount of power by using the algorithm for calculating the provided amount of power if the charging trade offer signal does not include the provided amount of power (operation S422). The algorithm for calculating the provided amount of power may be the algorithm for calculating the difference between the available amount of power and reserve amount of power of the charge-providing residence module as the provided amount of power.

In the searching for the rechargeable drive module (operation S430), the search processor 411 may search for the rechargeable drive module capable of being charged using the provided amount of power of the charge-providing residence module among the plurality of drive modules 300 located within the designated radius based on the current location of the charge-providing residence module.

According to this embodiment, in the searching for the rechargeable drive module (operation S430), the search processor 411 may search for the drive module 300 among the plurality of drive modules 300, in which the difference between its maximum capacity of the battery and the SOC is greater than the provided amount of power of the charge-providing residence module, as the rechargeable drive module.

According to this embodiment, in the searching for the rechargeable drive module (operation S430), when the plurality of rechargeable drive modules are searched for, the search processor 411 may search for the rechargeable drive module having the lowest SOC among the plurality of rechargeable drive modules or the rechargeable drive module that is closest to the charge-providing residence module as the rechargeable drive module having the highest priority.

In the calculating of the expected amount of power for the movement (operation S440), the charging cost calculation processor 412 may calculate the expected amount of power for the movement by using the information on the rechargeable drive module that is received from the search processor 411.

According to this embodiment, in the calculating of the expected amount of power for the movement (operation S440), the charging cost calculation processor 412 may calculate the expected amount of power for the movement by using the weight, aerodynamics, tire specification, motor output, reduction ratio, SOC, moving speed, external temperature, or the like of the rechargeable drive module as the calculation factor.

In the determining whether the rechargeable drive module is able to move, the charging control processor 410 may determine whether the rechargeable drive module is able to move by comparing the SOC received from the rechargeable drive module with the expected amount of power for the movement received from the charging cost calculation processor 412, and control the rechargeable drive module to be charged using the charge-providing residence module if the rechargeable drive module is determined to be able to move.

According to this embodiment, the determining whether the rechargeable drive module is able to move may include determining whether the rechargeable drive module is able to move to the charge-providing residence module by comparing the SOC of the rechargeable drive module with the expected amount of power for the movement (operation S451), and transmitting, to the rechargeable drive module, the signal instructing its movement to the charge-providing residence module if it is determined that the rechargeable drive module is able to move to the charge-providing residence module, and transmitting the signal for searching for another rechargeable drive module to the search processor 411 if it is determined that the rechargeable drive module is unable to move to the charge-providing residence module (operation S452).

The method described above may be written as a program that may be executed on a computer including one or more processors, and may be implemented on a general-purpose digital computer (including one or more processors) that operates the program by using a computer-readable recording medium. The computer-readable recording medium may include a storage medium such as a magnetic storage medium such as a read-only memory (ROM), a random access memory (RAM), a universal serial bus (USB), a floppy disk, a hard disk, or an optical readable medium such as a compact disc read-only memory (CD-ROM) or a digital video disc (DVD).

It can be understood that the scopes of the present disclosure are defined by the claims disclosed below rather than the detailed description provided above, and includes all alternations and modifications derived from the claims and their equivalents.

What is claimed is:

1. A system for providing a charging service for a separate mobility, the system comprising:
a search processor configured to search for a near-distance charging station closest to a current location of a charging-required drive module or a near-distance residence module closest to the current location of the charging-required drive module;
a charging cost calculation processor configured to:
calculate a first charging cost expected to incur when the charging-required drive module uses the near-distance charging station by using the current location of the charging-required drive module, a required charging amount for the charging-required drive module, and near-distance-charging-station information on the near-distance charging station, and
calculate a second charging cost expected to incur when the charging-required drive module uses the near-distance residence module by using the current location of the charging-required drive module, the required charging amount for the charging-required drive module, and near-distance-residence-module information on the near-distance residence module; and
a charging control processor configured to:
determine whether a given drive module is the charging-required drive module that is required to be charged based on a state of charge (SOC) of the given drive module,
comparing the first charging cost with the second charging cost to select one of the near-distance charging station and the near-distance residence module as a charger for the charging-required drive module, and
controlling a movement of the charging-required drive module for the charging-required drive module to be charged using the selected charger.

2. The system of claim 1, wherein the charging control processor is further configured to determine whether the given drive module is required to be charged based on whether the SOC of a battery mounted on the given drive module is a predetermined reference value or less.

3. The system of claim 1, wherein the charging control processor is further configured to determine whether the charging-required drive module is providing a mobility service to a specific residence module.

4. The system of claim 3, wherein the search processor is further configured to search for the near-distance charging station or the near-distance residence module based on an end point of the mobility service if it is determined that the charging-required drive module is providing the mobility service to the specific residence module.

5. The system of claim 1, wherein the charging cost calculation processor is further configured to:
calculate the first charging cost by using a first moving time required for the charging-required drive module to move from the current location to the near-distance charging station;
calculate a first charging time expected to be required to fully charge the charging-required drive module at the near-distance charging station;
calculate the required charging amount; and
calculate a charging fee by charging amount at the near-distance charging station.

6. The system of claim 1, wherein the charging cost calculation processor is further configured to:
calculate the second charging cost by using a second moving time required for the charging-required drive module to move from the current location to the near-distance residence module;
calculate a second charging time expected to be required to fully charge the charging-required drive module at the near-distance residence module;
calculate the required charging amount; and
calculate a charging fee by charging amount at the near-distance residence module.

7. The system of claim 1, wherein the charging control processor is further configured to:
select the near-distance charging station as the charger for the charging-required drive module if the first charging cost is equal to or less than the second charging cost; and
select the near-distance residence module as the charger for the charging-required drive module if the first charging cost is greater than the second charging cost.

8. The system of claim 1, wherein the charging control processor is further configured to transmit, to the charging-required drive module, a signal instructing movement of the charging-required drive module to the near-distance charging station if the near-distance charging station is selected as the charger for the charging-required drive module.

9. The system of claim 1, wherein the charging control processor is further configured to:
transmit a charging trade request signal to a first terminal of a first owner of the near-distance residence module if the near-distance residence module is selected as the charger for the charging-required drive module,
transmit, to the charging-required drive module, a signal instructing movement of the charging-required drive module to the near-distance residence module in response to an acceptance signal being received from the first terminal, and
transmit the charging trade request signal to a second terminal of a second owner of a next-priority residence module or transmit, to the charging-required drive module, a signal instructing the movement of the charging-required drive module to the near-distance charging station in response to a rejection signal being received from the first terminal.

10. The system of claim 9, wherein the charging control processor is further configured to determine that the charging trade request is rejected and perform a same operation as if the rejection signal is received from the first terminal, if there is no response to the charging trade request signal within a predetermined time.

11. The system of claim 1, wherein the charging control processor is further configured to:
transmit a trade conclusion notification signal to a terminal of an owner of the near-distance residence module; and
transmit, to the charging-required drive module, a signal instructing movement of the charging-required drive module to the near-distance residence module in response to an automatic acceptance signal being received from the terminal.

12. The system of claim 1, wherein the charging control processor is further configured to:
receive a charging trade offer signal from the near-distance residence module or a terminal to request a charge-providing residence module corresponding to the charging trade offer signal to transmit charge-providing-residence-module information on the charge-providing residence module;
determine whether the charging trade offer signal includes an amount of power provided by the charge-providing residence module;
transmit the charge-providing-residence-module information on the charge-providing residence module to the search processor if the charging trade offer signal includes the provided amount of power; and
transmit the charge-providing-residence-module information on the charge-providing residence module to the charging cost calculation processor if the charging trade offer signal does not include the provided amount of power.

13. The system of claim 12, wherein the search processor is further configured to search for a rechargeable drive module capable of being charged using the provided amount of power among a plurality of drive modules located within a designated radius based on the current location of the charge-providing residence module.

14. The system of claim 13, wherein the search processor is further configured to search for the given drive module among the plurality of drive modules, in which a difference between a battery maximum capacity and the SOC of the given drive module is greater than the provided amount of power, as the rechargeable drive module.

15. The system of claim 13, wherein the search processor is further configured to search for a given rechargeable drive module having a lowest SOC among a plurality of rechargeable drive modules as the rechargeable drive module having a highest priority when the plurality of rechargeable drive modules are searched.

16. The system of claim 12, wherein the charging cost calculation processor is further configured to calculate a difference between an available amount of power, which is stored in a battery mounted on the charge-providing residence module, and a reserve amount of power, which is expected to be required for the charge-providing residence module until a next charge of the charge-providing residence module, as the provided amount of power.

17. The system of claim 16, wherein the charging cost calculation processor is further configured to calculate an expected amount of power for the movement by using a weight, aerodynamics information, a tire specification, a motor output, a reduction ratio, a given SOC, a moving speed, or an external temperature of a rechargeable drive module as a calculation factor.

18. The system of claim 17, wherein the charging control processor is further configured to determine whether the rechargeable drive module is able to move to the charge-providing residence module by comparing the SOC received from the rechargeable drive module with the expected amount of power for the movement received from the charging cost calculation processor.

19. The system of claim 18, wherein the charging control processor is further configured to:
transmit, to the rechargeable drive module, a signal instructing the movement of the charge-providing residence module to the charge-providing residence module if it is determined that the rechargeable drive module is able to move to the charge-providing residence module, and
transmit, to the search processor, a search signal for searching for another rechargeable drive module if it is determined that the rechargeable drive module is unable to move to the charge-providing residence module.

20. A method for providing a charging service for a separate mobility, the method comprising:
receiving, by a charging control processor, a charging trade offer signal from a residence module or a terminal to request a charge-providing residence module corresponding to the charging trade offer signal to transmit charge-providing-residence-module information on the charge-providing residence module;
determining, by the charging control processor, whether the charging trade offer signal includes an amount of power provided by the charge-providing residence module;
searching for, by a search processor, a rechargeable drive module capable of being charged using the provided amount of power among a plurality of drive modules located within a designated radius based on a current location of the charge-providing residence module if the charging trade offer signal includes the amount of power provided by the charge-providing residence module;
receiving, by a charging cost calculation processor, rechargeable-drive-module information on the rechargeable drive module from the search processor;
calculating, by the charging cost calculation processor, an expected amount of power for a movement of the rechargeable drive module by using the rechargeable-drive-module information on the rechargeable drive module;
determining, by the charging control processor, whether the rechargeable drive module is able to move by comparing a state of charge (SOC) received from the rechargeable drive module with the expected amount of power for the movement received from the charging cost calculation processor; and
controlling, by the charging control processor, the movement of the rechargeable drive module for the rechargeable drive module to be charged using the charge-providing residence module if it is determined that the rechargeable drive module is able to move.
